(19) United States
(12) Patent Application Publication
(10) Pub. No.: US 2019/0312244 A1
(43) Pub. Date: Oct. 10, 2019

(54) BATTERY PACK ENCLOSURE

(71) Applicant: Hyperdrive Innovation Limited, Sunderland (GB)

(72) Inventors: Stephen Irish, Sunderland (GB); Robin Shaw, Sunderland (GB)

(73) Assignee: Hyperdrive Innovation Limited, Sunderland (GB)

(21) Appl. No.: 16/296,657

(22) PCT Filed: Sep. 12, 2017
(86) PCT No.: PCT/GB2017/052681

§ 371 Date: Mar. 8, 2019

(30) Foreign Application Priority Data
Sep. 12, 2016 (GB) 1615475.9

(51) Int. Cl. H01M 2/10

(52) U.S. Cl. CPC H01M 2/1077; H01M 2/1061

(57) ABSTRACT

A battery pack enclosure for holding a stack of batteries is disclosed. The battery pack enclosure comprises a lid section and a base section configured to hold a plurality of wall sections therebetween to encapsulate the stack of batteries. The sections comprise mutually complementary mating portions for mating with adjacent sections of the battery pack enclosure. The number of wall sections can be chosen to adjust the dimensions of the battery pack enclosure.

### FIELD OF THE INVENTION

The present disclosure relates to a battery pack enclosure and a method of assembling a battery pack enclosure.

### BACKGROUND

Batteries combine chemical and electrical elements. The chemical elements store electrical charge and need to be contained within the battery to ensure the battery operates effectively. In addition, the chemicals may be toxic or harmful to the environment, so there is a need to protect the chemical elements and ensure that the chemicals do not leak.

The electrical elements may also need to be protected, for example from water or from inadvertent contact by a user, for example to prevent short-circuiting of the battery. In addition, batteries generally need to be portable to fulfil their function of providing electrical power to systems where mains electricity may not be suitable.

Batteries are in general tailored to a specific purpose—for example their size, capacity and power output is selected to fulfil that specific purpose. This means, however, that a battery tailored for one specific purpose may not be suitable for another purpose, for example due to its size or capacity.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

### DRAWINGS

Embodiments of the disclosure will now be described, by way of example only, with reference to the accompanying drawings, in which:

FIG. 1 shows a perspective view of an example battery pack enclosure;

FIG. 2 shows another perspective view of an example battery pack enclosure, such as the battery pack enclosure of FIG. 1;

FIG. 3 shows a perspective view of the inside of the lid of a battery pack enclosure such as the battery pack enclosure of FIG. 1 or 2; FIG. 4 shows a cross-section through a battery pack enclosure such as the battery pack enclosure of FIG. 1 or 2;

FIG. 5 shows a perspective cross-section through a battery pack enclosure such as the battery pack enclosure of FIGS. 1, 2 and 4;

FIG. 6 shows another perspective cross-section through a battery pack enclosure such as the battery pack enclosure of FIGS. 1, 2 and 4; and

FIG. 7 shows an exploded cross-section of a battery pack, such as the battery pack enclosure of FIG. 5.

### SPECIFIC DESCRIPTION

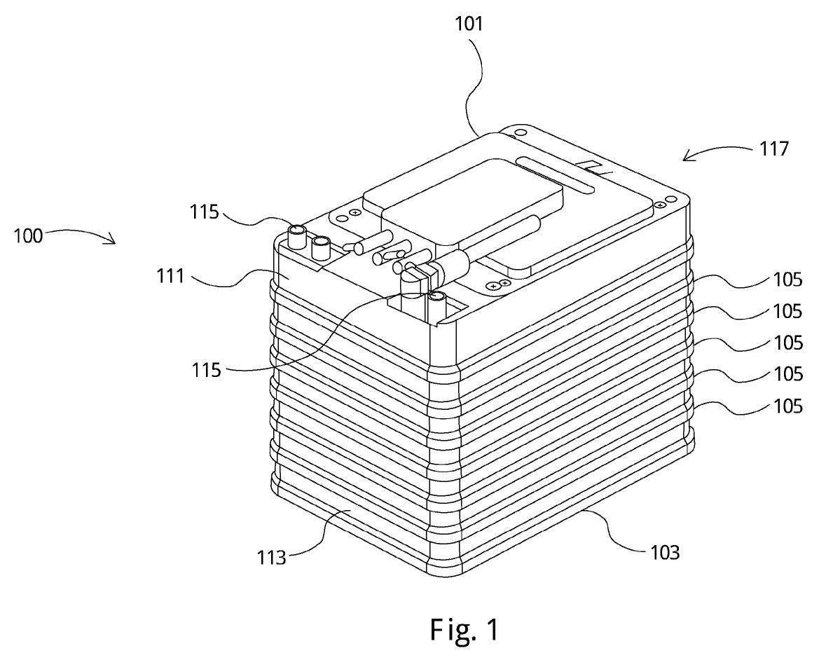

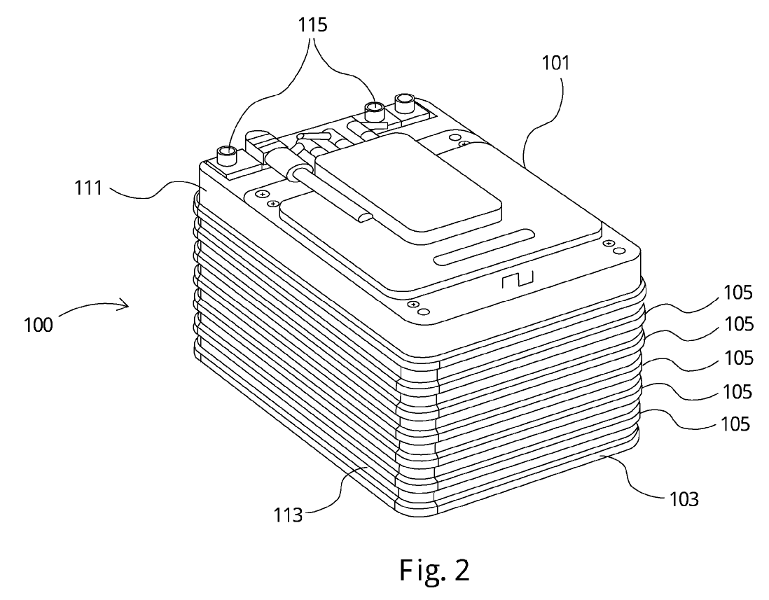

Embodiments of the disclosure relate to a battery pack enclosure, such as that shown in FIG. 1, for encapsulating a stack of batteries and that can be adjusted to accommodate differing sized stacks of batteries. The battery pack enclosure 100 comprises a lid 101 and a base 103 that are configured to hold a plurality of wall sections 105 therebetween to encapsulate a stack of batteries 900. The sections 101, 103, 105 comprise mutually complementary mating portions 151, 153 for mating with adjacent sections 101, 103, 105 of the battery pack enclosure 100.

Advantageously, the battery pack enclosure 100 of embodiments of the disclosure can therefore be modular, meaning that the battery pack enclosure 100 can be adjusted to be suitable for a number of different sized stacks of batteries 900 selected for a number of different purposes. One kit for assembling a battery pack enclosure 100 can therefore be provided to a user to allow the user to assemble a battery pack enclosure 100 suitable for their specific applications. The battery pack enclosure 100 may help protect the chemical and electrical elements of the batteries. Because the size of the battery pack enclosure 100 can be adjusted, the assembled battery pack enclosure 100 also helps to improve portability. In addition, because the battery pack enclosure 100 of the disclosure may be assembled bespoke for each intended purpose, the battery pack enclosure 100 can be assembled to fit the selected number of batteries needed for that purpose and therefore may reduce the carbon footprint of the battery pack enclosure 100 by reducing unnecessary packaging.

An example battery pack enclosure 100 is shown in more detail in FIG. 1. The battery pack enclosure 100 forms a box for encapsulating a stack of batteries 900. The battery pack enclosure 100 comprises a lid section 101 and a base section 103, and in the example shown in FIGS. 1 and 2, five wall sections 105 are held between the lid section 101 and the base section 103.

In the example shown, the wall sections 105 are identical to each other. The wall sections 105 are generally rectangular with rounded corners and in the examples shown have a height that corresponds to the thickness of a battery in the stack of batteries 900. The wall sections 105 have a circumference selected to encircle each battery of the stack of the batteries 900 and are continuous in the circumferential direction so that they form a loop or ring around the stack of batteries 900. The wall sections 105 are open at either end so that, when assembled, a stack of wall sections 105 may form a tubular structure.

The lid section 101 is generally rectangular and provides a dome or inverse trough to cap a stack of batteries 900 encapsulated by the battery pack enclosure 100. The lid section 101 has substantially the same width and length as each of the wall sections 105. The lid section 101 comprises a lower wall section 111 extending from a substantially flat cap portion 117. Like the wall sections 105, the lower wall section 111 of the lid section 101 has rounded corners and is continuous in the circumferential direction so that it forms a loop or ring around the stack of batteries 900 and has substantially the same circumference as the wall sections 105. The flat cap portion 117 may comprise indents or other variations in profile to accommodate for other features of the battery pack enclosure 100, such as a battery management system 170 or terminals 115, as will be described in more detail below.

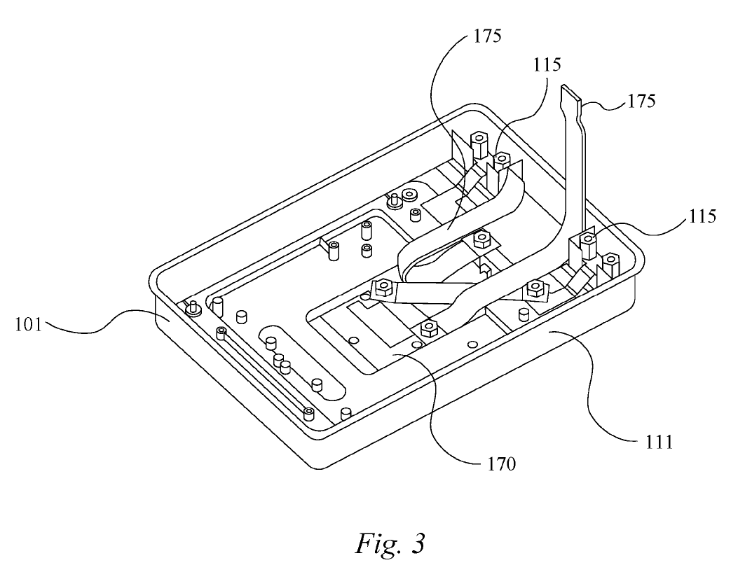

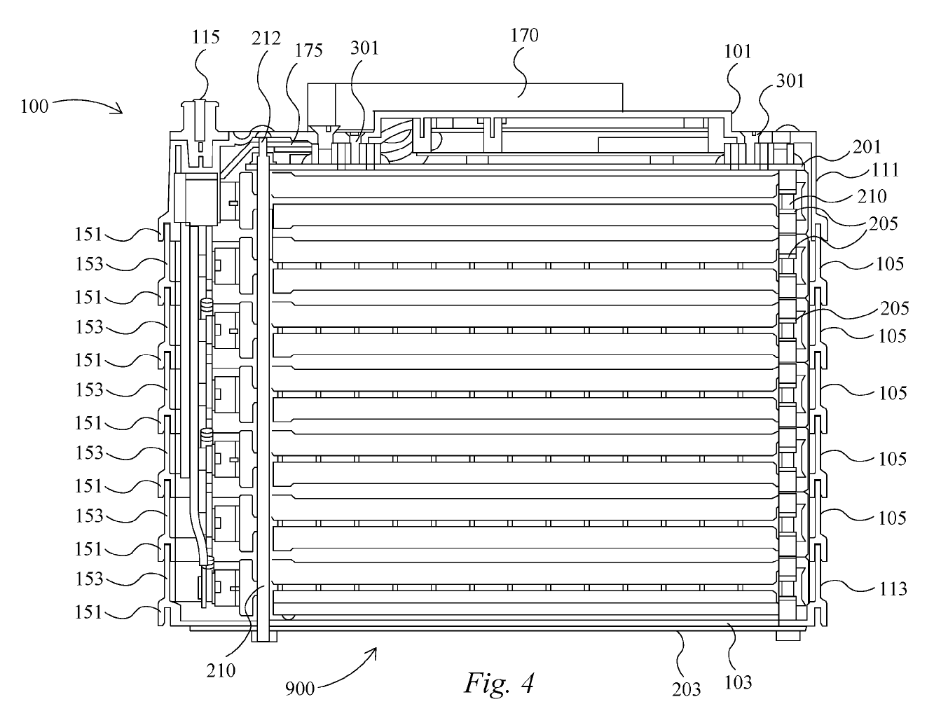

The lower wall section 111 extending from the flat cap portion 117 of the lid section 101 is complementary to each of the wall sections 105 forming the battery pack enclosure 100. The lid section 101 comprises at least two terminals 115 electrically coupled to the stack of batteries 900 inside the battery pack enclosure 100. The lid section 101 also comprises a battery management system, BMS, 170 in a recess on the underside of the lid 101. The BMS 170 is coupled in series to the stack of batteries 900 encapsulated by the battery pack enclosure 100 by a pair of flexible bus bars 175, as will be described in more detail below with reference to FIG. 3.

The base section 103 is also generally rectangular and in general terms is the complement to the lid section 101. It has substantially the same width and length as the lid section 101 and each of the wall sections 105. The base section 103 has a flat base. Upstanding from the flat base is an upper wall section 113, again complementary to each of the wall sections 105 forming the battery pack enclosure 100. Like the wall section 105 and the lower wall section 111 of the lid section 101, the upper wall section 113 of the base section 103 has rounded corners and is continuous in the circumferential direction so that it forms a loop or ring around the stack of batteries 900 and has substantially the same circumference as the wall sections 105.

Each of the sections 101, 103, 105 may be made from a resilient waterproof material, for example tough engineering plastic, such as glass-filled polycarbonate or nylon.

The wall sections 105 each comprise mutually complementary mating portions 151, 153. In the example shown in FIGS. 1 and 2, the lid section 101 and base section 103 also comprise mutually complementary mating portions 151, 153 although it will be understood that in other examples the lid section 101 and base section 103 do not comprise mutually complementary mating portions.

Each of the plurality of wall sections 105 comprise an upper mating portion 153 and a lower mating portion 151, the upper and lower mating portions on opposing sides of the wall section 105. The upper and lower mating portions 151, 153 face in opposite directions, and in the examples shown, are on opposite edges of each wall section 105. In the example shown in FIGS. 1 and 2, the base 103 also comprises an upper mating portion 153 along the top edge of the upper wall section 113 and the lid section 101 comprises a lower mating portion 151 along the bottom edge of the lower wall section 111.

At least one of the complementary mating portions 151, 153 comprises a seat member. For example, the upper and lower mating portions 151, 153 comprise at least one of (a) a seat member, and (b) a protrusion. In the examples shown, the lower mating portion 151 comprises a seat member, and the upper mating portion 153 comprises a protrusion. The lid section 101 (in particular the bottom edge of the lower wall section 111) and the lower edge of each wall section 105 each comprise a seat member 151. The seat member 151 comprises a groove. The groove is arranged to mate with and partially surround a corresponding protrusion 153 of the complementary mating portion of an adjacent section 101, 103, 105 of the battery pack enclosure 100.

In the examples shown the complementary mating portions 151, 153 extend around the entire circumference of each of the sections 101, 103, 105 of the battery pack enclosure 100. However, it will be understood that the complementary mating portions 151, 153 may only partially encircle each of the sections 101, 103, 105 of the battery pack enclosure 100. For example, the complementary mating portions 151, 154 may be spaced at intervals around the circumference of the sections 101, 103, 105 of the battery pack enclosure 100, or may be on opposing edges of the section 101, 103, 105, for example opposing upper or lower edges of each section 101, 103, 105, either side of the stack of batteries 900.

In some examples, however, the upper and lower mating portions 151, 153 of at least one of the wall sections 105 are the same type of mating portion—for example, one wall section 105 may comprise an upper and lower seat member 151 on opposing sides of the wall section 105, or may comprise upper and lower protrusions 153 on opposing sides of the wall section 105. In this way, not all wall sections 105 therefore need to be identical. Similarly, the complementary mating portions 151, 153 of the lid section 101 and base section 103, if present, may, in some examples, be the same type (and therefore not be complementary to each other), for example, both may comprise seat members, and each wall section 105 may comprise protrusions to sit within the seat members.

The battery pack enclosure 100 also comprises a flexible seal between complementary mating portions 151, 153 of adjacent sections 101, 103, 105 of the battery pack enclosure 100. The flexible seal may extend around the circumference of the adjacent sections 101, 103, 105. For example, the flexible seal may form a ring. The flexible seal may comprise a resilient material such as rubber, for example the flexible seal may be a rubber O-ring. The flexible seal may sit within the groove of the seat member 151 of the complementary mating portion, for example.

Each wall section 105 also comprises a plurality of ridges on an internal face facing the stack of batteries 900. The upper wall section 113 of the base section 103 and the lower wall section 11 of the lid section 101 may also comprise a plurality of ridges. Each ridge of the plurality of ridges may extend on the internal face from a complementary mating portion 151, 153 and in a height direction, parallel to a longitudinal axis of the holes 205 and studs 210 that will be described in more detail below.

Turning to FIG. 3, the stack of batteries 900 encapsulated by the battery pack enclosure 100 are electrically coupled to the terminals 115 of the lid section 101 by a pair of flexible bus bars 175. In some examples each battery of the stack of batteries 900 comprises a thermistor arranged to provide a temperature signal to the BMS 170 based on a temperature of the battery.

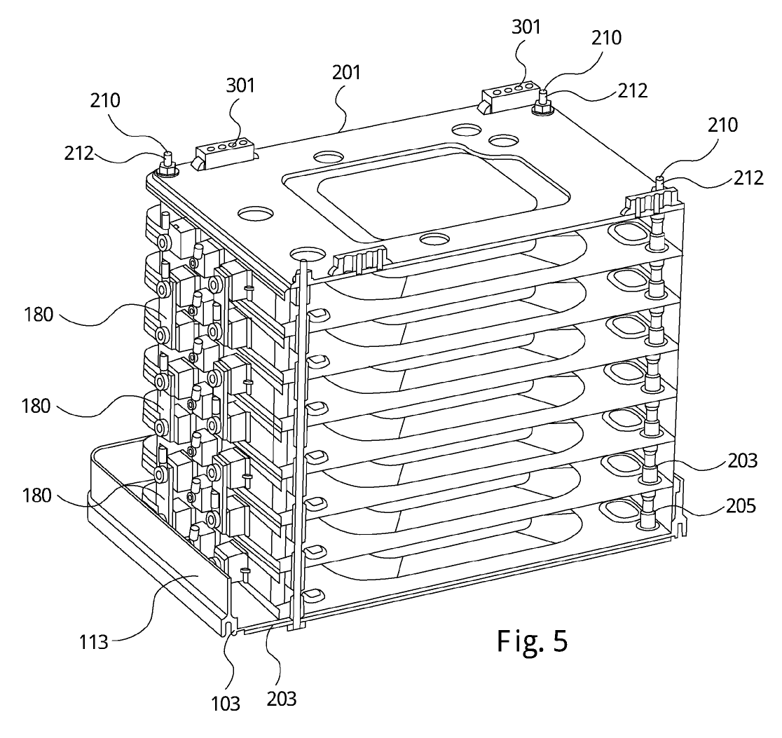

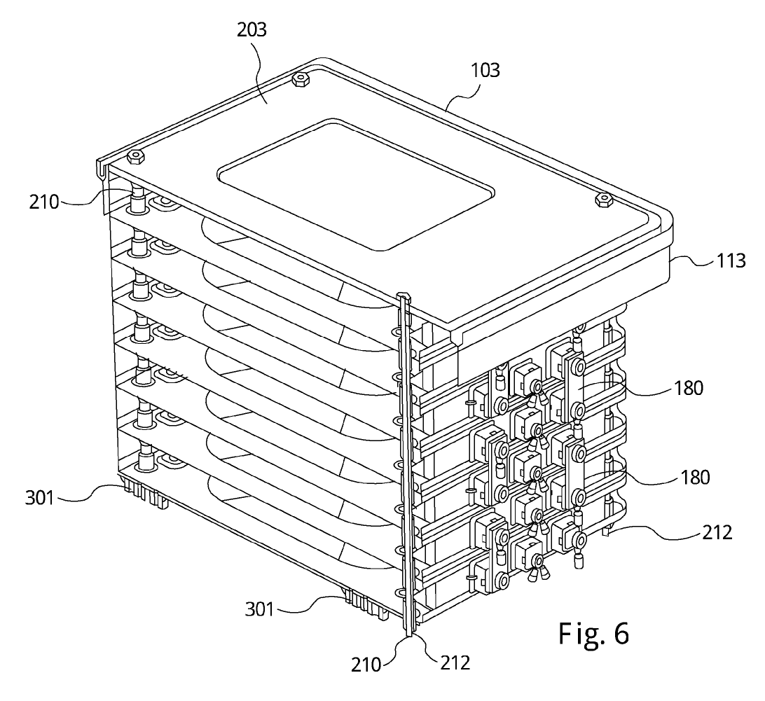

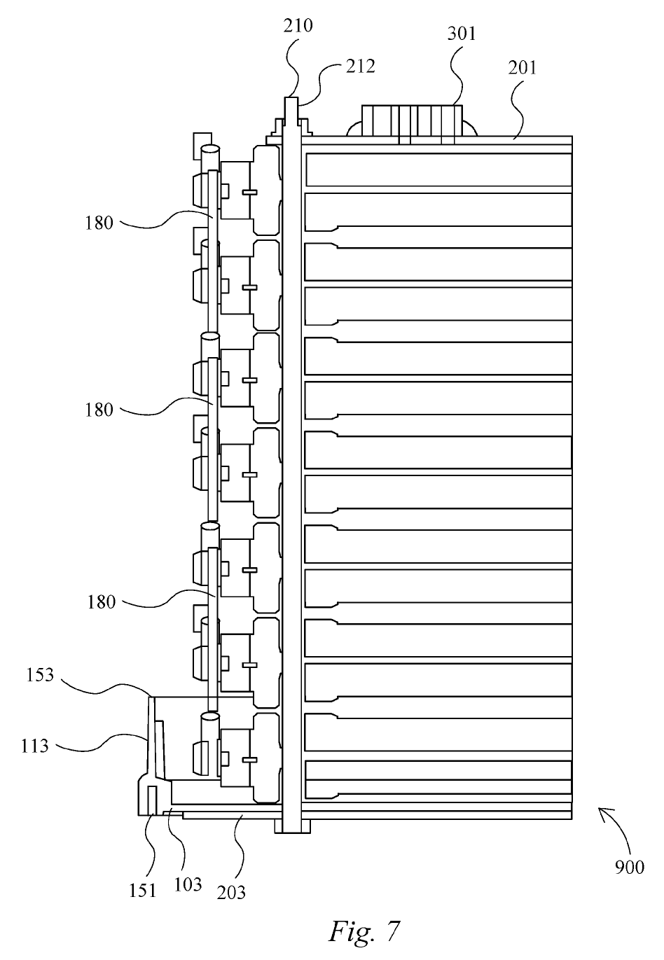

Turning to FIGS. 4, 5 and 6, the lid section 101 is mechanically coupled to a first plate 201 via a coupling 301 on the first plate 201. The lid section 101 may be adapted to couple with the coupling 301. The base section 103 is mechanically coupled to a second plate 203. The lid section 101 may be coupled to the first plate 201 via a plurality of couplings 301. Each coupling 301 may be detachable, for example comprising a screw and thread, so that the coupling can be undone and the lid section 101 separated from the first plate 201. The couplings 301 may be distributed around the circumference of the lid section 101 and the first plate 201. The base section 101 may be mechanically coupled to the second plate 203 via a stud 210 that passes through the stack of batteries 900 as will be described in more detail below. The first and second plates 201, 203 are resilient, and for example may be manufactured from metal such as steel. For example, the plates 201, 203 may be sprung, for example made from sprung steel.

Each battery of the stack of batteries 900 comprises a generally cuboidal enclosure that houses at least one battery cell. Between each battery of the stack of batteries 900 there may be a tray or plate 205 that acts to support each battery of the stack of batteries 900. The enclosure housing the battery cell may form a battery module. Each battery module may be identical.

Each battery of the stack of batteries 900 comprises at least one hole 205 for a stud 210 to pass therethrough. In the example shown, each battery comprises four holes 205, each hole 205 at a respective corner of each battery. The hole 205 extends through the thickness of the battery in a height direction of the stack of batteries 900. The thickness of a battery is its smallest dimension. The spacing between holes 205 for each battery of the stack of batteries 900 is the same. In the examples shown the holes have an 8 mm diameter. The respective holes 205 of each battery of the stack of batteries 900 are aligned to provide a series of holes 205 that extend throughout the height/thickness of the stack of batteries 900 in a longitudinal (height) direction.

A plurality of studs 210 each pass through the respective holes 205 of each of the batteries of the stack of batteries 900 and pass through the stack of batteries 900. Each stud mechanically couples the first plate 201 and the second plate 203 together on opposite sides of the stack of batteries 900. Each stud 210 clamps the batteries of the stack of batteries 900 together in the enclosure 100. Each stud 210 is smaller in diameter than the diameter of the holes 205 through each battery of the stack of batteries 900. In the example shown, each stud 210 has a 6 mm diameter.

In the example shown, each stud 210 comprises a threaded end at an end adjacent to the first plate 201 and a bolt head at the other end adjacent to the second plate 203. The threaded end further comprises a locking portion 212, for example adapted to fit a tool such as a spanner. The first plate 201 and second plate 203 are mechanically coupled by a nut threaded onto the threaded end of the stud 210. For example, the diameter of the nut and the bolt head may be greater than the diameter of the holes 205 through each battery of the stack of batteries 900. In some examples, however, each stud 210 may be integrated into one of the plates 201, 203—for example, each stud 210 may be integrated into the second plate 203. In other examples, each stud 210 may couple into a standoff from one of the plates 201, 203. For example, each stud 210 may be a threaded bar.

In the examples shown, the second plate 203 is arranged to be outside the base section 103 relative to the stack of batteries 900 and so acts to clamp the base section 103 between the second plate 203 and the stack of batteries 900. In some examples the base section 103, however, may be outside the second plate 203. In some examples, the stud 210 may comprise a resilient bush or collar that at least partially encircles each stud 210 and acts to transfer load between the second plate 203 and the stack of batteries 900 and optionally one of the trays 205 supporting the stack of batteries 900.

Each battery of the stack of batteries 900 is electrically insulated from the studs 210 and the plates 201, 203, 205. For example, each battery of the stack of batteries 900 comprises an insulating sleeve held in each hole 205 between each stud 210 and each battery of the stack of batteries 900, the sleeve at least partially surrounding and being held in place by the stud 210 coupled to the first and second plates 201, 203.

As noted above, each battery of the stack of batteries 900 is coupled to the terminals 115 of the lid section 101 by a pair of bus bars 175. The bus bars 175 are more flexible than the studs 210 or plates 201, 203, 205 for mechanically clamping the stack of batteries 900. Each battery of the stack of batteries 900 has a long edge and a short edge. Each battery of the stack of batteries 900 comprises at least three terminals on their short edge, two of the terminals arranged for electrically coupling the battery to other batteries of the stack of batteries 900 and one of the terminals arranged for electrically coupling to at least one of a thermistor and a balancing harness.

The batteries of the stack of batteries 900 are also coupled to each other via a plurality of rigid bus bars 180. The rigid bus bars 180 electrically couple the batteries of the stack of batteries 900 on their short edge. The rigid bus bars 180 alternate in sequence (from side to side along the short edges) along the height of the stack 900. This is because the rigid bus bars 180 electrically couple the batteries of the stack of batteries 900 in series and because the batteries are stacked in an alternating order (i.e. opposite polarity on same side of short edge of each battery). In other words, every alternate battery of the stack 900 is arranged upside down (i.e. flipped like a pancake) relative to the other batteries of the stack 900. In this way, the polarity of the terminals of the batteries in a stack 900 alternates so that a terminal of a lower battery has an opposite polarity to an adjacent terminal of an adjacent upper battery in the stack of batteries 900. In this way, the orientation of batteries 900 relative to each other in a stack of batteries can be selected to more efficiently electrically couple the batteries of a stack of batteries 900 together, for example with the bus bar 180. It will of course, however, be understood that in other examples the batteries of a stack of batteries 900 may be stacked in the same orientation or in other orientations.

The lid section 101 and the base section 103 are configured to hold the plurality of wall sections 105 therebetween to encapsulate the stack of batteries 900.

At least one of the wall sections 105 is adapted to couple with the lid section 101 and at least one of the wall sections 101 is adapted to couple with the base section 103. The coupling between the lid section 101 and at least one of the wall sections 105, and between the base section 103 and at least one of the wall sections 105 is via the mutually complementary mating portions 151, 153 in the examples shown, although it will be understood that in other examples the coupling between the base section 103 and a wall section 105 and the lid section 101 and a wall section 105 may take another form—for example, each of the lid section 101 and base section 103 may comprises recesses to slidingly receive portions of the wall sections 105.

The mutually complementary mating portions 151, 153 of the wall sections 105 and optionally the lid and base sections 101, 103, are configured to be interchangeable so that the battery pack enclosure 100 can be modular. For example, each of the wall sections 105 is stackable. For example, each of the wall sections is stackable with the lid section 101 and the base section 103.

In the example shown, the mutually complementary mating portions 151, 153 of each wall section 105, lid section 101 and base section 103 are configured to mate with each other to couple adjacent sections 101, 103, 105 of the battery pack enclosure 100. For example, the base section 103 is adapted to couple with a wall section 105 and/or the lid section 101. Each wall section 105 may be adapted to couple with another wall section 105, the lid section 101 or the base section 103. The lid section 101 may be adapted to couple with a wall section 105 and/or the base section 103.

The number of wall sections 105 can be chosen to adjust the dimensions of the battery pack enclosure 100. In some examples the battery pack enclosure 100 may comprise no wall sections 105. In the examples shown, the base section 103 can couple directly to the lid section 101 or can couple to the lid section 101 via the plurality of wall sections 105.

Each of the plurality of wall sections 105 is arranged to encircle the stack of batteries 900. For example, the dimensions (in terms of width, depth and length) of each of the wall sections 105 may be greater than at least one, at least two, at least three dimensions of one of the batteries of the stack of batteries 900. Similarly, the lid section 101 and base section 103 are arranged to at least partially encircle the stack of batteries 900.

The seat member, for example the groove, of the lower mating portion 151 is adapted to at least partially surround a corresponding portion, such as a protrusion, for example the upper mating portion 153, of an adjacent section 101, 103, 105 of the battery pack enclosure 100. The mutually complementary mating portions 151, 153 are configured to provide an interference fit. The mutually complementary mating portions 151, 153 are also adapted to mechanically support adjacent sections 101, 103, 105 of the battery pack enclosure 100. The mutually complementary mating portions 151, 153 are also configured to inhibit the ingress of water into the enclosure 100, for example with the aid of the flexible seal.

Each ridge of the plurality of ridges extending in a height direction on the inner face of the sections 101, 103, 105, may be arranged to mechanically strengthen the enclosure 100, for example to support an adjacent section 101, 103, 105 of the battery pack enclosure 100. Each of the plurality of ridges may additionally or alternatively be arranged to act as a bumper for the stack of batteries 900 to contact the stack of batteries 900 to inhibit movement of the stack of batteries 900 in the enclosure 100, and also to provide a series of coolant flow channels to allow a coolant such as air to flow, for example in a longitudinal or height direction, between and/or along the batteries of the stack of batteries 900.

Each of the studs 210 that passes through the respective holes 205 of each of the batteries of the stack of batteries 900 is arranged to mechanically clamp the stack of batteries 900 between the first plate 201 and the second plate 203. The first and second plates 201, 203 act to distribute the pressure over the end batteries of the stack of batteries 900 due to the clamping force. Because the couplings 301 on the lid section 101 are configured to mechanically couple the lid section 101 to the first plate 201, and the base section 103 is clamped between the stack of batteries 900 and the second plate 203, each stud 210 (when fastened to the selected torque) is therefore arranged to hold the enclosure 100 together and to hold each of the plurality of wall sections 105 between the lid section 101 and the base section 103, for example to clamp the wall sections 105 between the lid section 101 and the base section 103.

The BMS 170 in the lid section 101 is configured to control charge in the batteries of the stack of batteries 900. For example, the BMS 170 is configured to balance charge across the batteries of the stack of batteries 900 via a balancing harness coupled to each of the batteries of the stack of batteries 900.

The flexible bus bars 175 are arranged to act as a mechanical hinge for the lid section 101 to the enclosure 900, thus allowing the lid section 101 to be removed, for example for maintenance, while leaving the BMS 170 in the lid section 101 coupled to the stack of batteries 900.

The battery pack enclosure 100 is assembled by choosing the number of wall sections 105 based on the number of batteries in the stack of batteries 900. Accordingly, another aspect of the disclosure provides a method of assembling a battery pack enclosure, such as the battery pack enclosure 100 described above.

The method comprises determining the number of batteries in a stack of batteries 900 to be enclosed by the battery pack enclosure 100 and providing a number of wall sections 105 based on the determination of the number of batteries in the stack of batteries 900. If there are a low number of batteries in the stack of batteries 900, for example two batteries in the stack of batteries 900, this may mean that no wall sections 105 are provided.

The determined number of wall sections 105 are coupled together via their mutually complementary mating portions 151, 153 and held between the base section 103 and the lid section 101 to enclose the stack of batteries 900. This may comprise coupling the lid section 101 to a wall section 105 and coupling the base section 103 to the same wall section 105 or another wall section 105. Coupling the lid section 101 to a wall section 105, and coupling the base section 103 to a wall section 105 may comprise coupling adjacent sections 101, 103, 105 via the mutually complementary mating portions 151, 153.

The mechanical coupling between each stud 210 and the first and second plates 201, 203 is tightened to a selected torque, for example using a torque wrench, to clamp the stack of batteries 900 to a selected degree of pressure. The locking portion 212 that may be adapted to fit a tool such as a spanner at the end of each of the studs 210 allows the mechanical coupling to be tightened to the selected torque without twisting of the stud 201 occurring during assembly. In effect, the locking portion 212 at the end of each stud 210 is an anti-twisting feature.

Because the lid section 101 is coupled to the first plate 201, and the base section 103 is coupled to the second plate 103, the stud 210 acts to hold the enclosure 100 together. When the lid section 101 is coupled to the first plate 201 via each of the couplings 301, and each stud 210 is tightened to the selected torque, the complementary mating portions 151, 153 of adjacent sections 101, 103, 105 mate with each other, for example in a sliding relationship, to provide an interference fit and/or a watertight seal.

Another aspect of the disclosure provides a kit of parts for assembling a battery pack enclosure such as the battery pack enclosure 100 described above.

Of course it will be understood that only one form of complementary mating portions 151, 153 has been described and that other variations of complementary mating portions may be used. For example, the complementary mating portions 151, 153 may be configured to provide any other form of stackable structure, such as a series of angled or bevelled edges that can stack in a manner similar to that of a stack of cones. In other examples the complementary mating portions may comprise a toggle and clip, for example the upper mating portion 153 may comprise a toggle that clips onto and fastens to a clip providing a lower mating portion 151 on an adjacent section 101, 103, 105 of the enclosure 100. In some examples the complementary mating portions 151, 153 may each be provided, for example, on opposing edges of a wall section 105 but on the same face of a wall section 105. For example if the upper and lower mating portions 151, 153 comprise a toggle and clip, the toggle and clip may both be provided on an outer face of the sections 101, 103, 105 of the enclosure 100.

It will be appreciated from the discussion above that the embodiments shown in the Figures are merely exemplary, and include features which may be generalised, removed or replaced as described herein and as set out in the claims. For example, the complementary mating portions 151, 153 provided on the lid section 101 and/or base section 103 may be removed or replaced as described above. The form of the complementary mating portions 151, 153 may also be generalised or changed as described above. In the context of the present disclosure other examples and variations of the apparatus and methods described herein will be apparent to a person of skill in the art.

1. A battery pack enclosure for holding a stack of batteries;
wherein the battery pack enclosure comprises a lid section and a base section configured to hold a plurality of wall sections therebetween to encapsulate the stack of batteries; and
wherein the sections comprise mutually complementary mating portions for mating with adjacent sections of the battery pack enclosure;
and wherein the number of wall sections can be chosen to adjust the dimensions of the battery pack enclosure.

2. The battery pack enclosure of claim 1 wherein the base section and the lid section comprise mutually complementary mating portions, so that the base section can couple directly to the lid section or can couple to the lid section via the plurality of wall sections.

3. The battery pack enclosure of claim 1 or 2 wherein at least one of the complementary mating portions comprises a seat member adapted to at least partially surround a corresponding portion of an adjacent section of the battery pack enclosure.

4. The battery pack enclosure of claim 3 wherein the seat member comprises a groove, the groove arranged to mate with and partially surround a corresponding protrusion of an adjacent section of the battery pack enclosure.

5. A battery pack enclosure for holding a stack of batteries;
wherein the battery pack enclosure comprises a lid section and a base section configured to hold a plurality of wall sections therebetween to encapsulate the stack of batteries; and
wherein the plurality of wall sections comprise mutually complementary mating portions for mating with adjacent wall sections;
and wherein the number of wall sections can be chosen to adjust the dimensions of the battery pack enclosure.

6. The battery pack enclosure of any of the previous claims wherein each of the plurality of wall sections is arranged to encircle the stack of batteries.

7. The battery pack enclosure of any of the previous claims wherein each of the plurality of wall sections comprise an upper mating portion and a lower mating portion, the upper and lower mating portions on opposing sides of the wall section.

8. The battery pack enclosure of claim 7 wherein the upper and lower mating portions of at least one of the wall sections are the same type of mating portion.

9. The battery pack enclosure of claim 8 wherein the upper and lower mating portions comprise at least one of (a) a seat member adapted to at least partially surround a corresponding portion of an adjacent section of the battery pack enclosure, and (b) a protrusion adapted to be received and at least partially surrounded by a seat member of an adjacent section of the battery pack enclosure.

10. The battery pack enclosure of any of the previous claims wherein at least one of the wall sections is adapted to couple with the lid section and at least one of the wall sections is adapted to couple with the base section.

11. The battery pack enclosure of any of the previous claims wherein the mutually complementary mating portions provide an interference fit.

12. The battery pack enclosure of any of the previous claims wherein the mutually complementary mating portions are adapted to mechanically support adjacent sections of the battery pack enclosure.

13. The battery pack enclosure of any of the previous claims wherein the mutually complementary mating portions are configured to inhibit the ingress of water into the enclosure.

14. The battery pack enclosure of any of the previous claims comprising a flexible seal between complementary mating portions of adjacent sections of the battery pack enclosure.

15. The battery pack enclosure of any the previous claims wherein each wall section comprises a plurality of ridges on an internal face facing the stack of batteries, each ridge arranged to mechanically support an adjacent section of the battery pack enclosure.

16. The battery pack enclosure of claim 15 wherein each ridge of the plurality of ridges extends on the internal face from a complementary mating portion.

17. The battery pack enclosure of any of the previous claims wherein the lid section has a coupling configured to mechanically couple the lid to a first plate and the base section has a coupling configured to mechanically couple the base section to a second plate; and
wherein each battery of the stack of batteries comprises at least one hole for a stud to pass therethrough, the stud arranged to mechanically couple to the first plate and the second plate on opposite sides of the stack of batteries to clamp the batteries of the stack of batteries together in the enclosure.

18. A battery pack enclosure for holding a stack of batteries;
wherein the battery pack enclosure comprises a lid section and a base section arranged to hold a plurality of wall sections therebetween to encapsulate the stack of batteries and wherein the lid section has a coupling configured to mechanically couple the lid section to a first plate and the base section has a coupling configured to mechanically couple the base section to a second plate; and
wherein each battery of the stack of batteries comprises at least one hole for a stud to pass therethrough, the stud arranged to mechanically couple to the first plate and the second plate on opposite sides of the stack of batteries to clamp the batteries of the stack of batteries together in the enclosure.

19. The battery pack enclosure of claim 17 or 18 wherein the second plate is arranged to be outside the base relative to the stack of batteries, and the base is coupled to the second plate by the stud.

20. The battery pack enclosure of claim 19 comprising a bush arranged to at least partially encircle the stud and transfer load from the plate outside the base section to the stack of batteries.

21. The battery pack enclosure of any of claims 17 to 20 wherein the wall sections are arranged to be clamped between the lid section and the base section by the stud when the lid section is coupled to the first plate and the base section is coupled to the second plate.

22. The battery pack enclosure of any of claims 17 to 21 wherein the lid section comprises at least two terminals electrically coupled to the stack of batteries inside the battery pack enclosure, wherein the stack of batteries are electrically coupled to the terminals of the lid section by a bus bar that is more flexible than the studs or plates for mechanically clamping the batteries, wherein the bus bar is arranged to act as a mechanical hinge for the lid section to the enclosure.

23. The battery pack enclosure of any of claims 17 to 22 wherein the stud is integrated into the second plate.

24. The battery pack enclosure of any of claims 17 to 23 wherein each battery of the stack of batteries is electrically insulated from the stud and the plates.

25. The battery pack enclosure of any of claims 17 to 24 further comprising an insulating sleeve held between the stud and each battery of the stack of batteries, the sleeve arranged to at least partially surround and be held in place by the stud coupled to the first and second plates.

26. The battery pack enclosure of any of claims 17 to 25 wherein each battery comprises a plurality of holes for respective studs to pass therethrough, wherein the spacing between holes for each battery is the same.

27. The battery pack enclosure of claim 26 wherein each battery has four holes, each hole at respective corner of the battery.

28. The battery pack enclosure of any of claims 17 to 27 wherein the hole through the battery has an 8 mm diameter.

29. The battery pack enclosure of any of claims 17 to 28 wherein the stud has a 6 mm diameter.

30. The battery pack enclosure of any of the previous claims wherein the number of wall sections is chosen based on the number of batteries in the stack of batteries.

31. The battery pack enclosure of any of the previous claims wherein each battery comprises at least three terminals, two of the terminals arranged for electrically coupling the battery to other batteries of the stack of batteries and one of the terminals arranged for electrically coupling to at least one of a thermistor and a balancing harness.

32. The battery pack enclosure of any of the previous claims wherein each battery of the stack of batteries is coupled by a balancing harness arranged for balancing charge between the batteries of the stack of batteries.

33. The battery pack enclosure of any of the previous claims, wherein the lid section comprises a battery management system, BMS, for coupling to the stack of batteries for controlling charge in the batteries.

34. The battery pack enclosure of claim 33 as dependent on claim 22 wherein the BMS is coupled in series to the stack of batteries by the flexible bus bar.

35. The battery pack enclosure of claim 33 or 34 wherein the lid section comprises a recess for the BMS.

36. The battery pack enclosure of claim 33 as dependent on claim 32, or any claim dependent thereon, wherein the BMS is configured to balance charge across the batteries of the stack of batteries via the balancing harness.

37. The battery pack enclosure of any of claims 33 to 36 wherein each battery of the stack of batteries comprises a thermistor arranged to provide a temperature signal to the BMS based on a temperature of the battery.

38. The battery pack enclosure of any of the previous claims comprising the stack of batteries.

39. A battery pack enclosure substantially as described herein with reference to the accompanying drawings.

40. The battery pack enclosure of any of the previous claims provided as a kit of parts for assembly.

41. A method of assembling a battery pack enclosure for holding a stack of batteries, the method comprising:
determining the number of batteries in a stack of batteries to be enclosed by the battery pack enclosure;
providing a number of wall sections based on the determination of the number of batteries in the stack of batteries;
coupling the determined number of wall sections together via mutually complementary mating portions;
holding the determined number of wall sections between a base section and a lid section to enclose the stack of batteries.

42. The method of claim 41 wherein holding the determined number of wall sections between a base section and a lid section comprises coupling the lid section to a wall section and coupling the base section to a wall section.

43. The method of claim 42 wherein the lid section and the base section comprise a mating portion for mating with adjacent sections of the battery pack enclosure, and wherein coupling the lid section to a wall section and coupling the base section to a wall section comprises coupling adjacent sections via the mating portions.

44. The method of claim 42 or 43 wherein the lid section and the base section comprise the same mutually complementary mating portions as the wall sections, and wherein coupling the lid section to a wall section and coupling the base section to a wall section comprises coupling adjacent sections via the mutually complementary mating portions.

45. A method of assembly substantially as described herein with reference to the drawings.
